(19) United States
(12) Patent Application Publication
(10) Pub. No.: US 2020/0086314 A1
(43) Pub. Date: Mar. 19, 2020

(54) CHIP FOR SAMPLE DETECTION AND PACKAGING METHOD THEREOF

(71) Applicants: Tianjin MNCHIP Technologies Co., Ltd., Tianjin (CN); Suzhou MNCHIP Technologies Co., Ltd., Suzhou (CN)

(72) Inventors: Zhanhui WANG, Tianjin (CN); Fanglu CHEN, Binzhou (CN)

(21) Appl. No.: 16/691,541

(22) Filed: Nov. 21, 2019

Related U.S. Application Data
(63) Continuation of application No. PCT/CN2018/086363, filed on May 10, 2018.

(30) Foreign Application Priority Data
May 22, 2017 (CN) 201710364719.7

(51) Int. Cl. B01L 3/00

(52) U.S. Cl. CPC B01L 3/502707; B01L 2300/12; B01L 2300/0803; B01L 2200/0689

(57) ABSTRACT

A chip for sample detection includes a substrate, an upper covering plate disposed above the substrate and a lower covering plate disposed under the substrate. A gap between an upper end face of the substrate and the upper covering plate is sealed, a gap between a lower end face of the substrate and the lower covering plate is sealed, and the substrate is provided with a via hole penetrating the upper end face and the lower end face.

### CROSS-REFERENCE TO RELATED APPLICATIONS

This application is a continuation of International Application No. PCT/CN2018/086363 filed on May 10, 2018, which claims priority to Chinese patent application No. 201710364719.7 filed on May 22, 2017. Both applications are incorporated herein by reference in their entireties.

### TECHNICAL FIELD

The present application relates to the field of sample detection technologies, in particular to a chip for sample detection and a packaging method thereof.

### BACKGROUND

Microfluidic chip technology is a systematic science technology for precisely controlling a very small amount of fluid (generally microliter, nanoliter or picoliter magnitude) in micron-scale flow channels, and is an important information collection and processing platform for modern biological and chemical science. Application of such a technology can integrate or substantially integrate basic operations used in the biochemical fields, such as sample preparation, reaction, detection, separation or cell culture, sorting, lysis, etc., into a microchip, and a network is formed by micro channels, so that the fluid may be controlled throughout a whole system. This not only enables automated operations, detection and analysis in the traditional biological and chemical experiments, but also successfully implements some experiments that are difficult or impossible to be completed under a traditional biological and chemical mean. The microfluidic chip technology has been widely used in biology, chemistry, medicine and other fields for its advantages of flexible combination and scale integration of various unit technologies on a whole controllable micro platform.

### SUMMARY

In view of this, embodiments of the present application is dedicated to providing a chip for sample detection and a packaging method thereof to solve the technical problem that when the chip in the prior art is applied in the field of optical detection, production cost of the chip is high because the material itself has high requirements on light transmittance, production process is relatively complex, and the like.

One aspect of the present application provides a chip for sample detection, which includes: a substrate; an upper covering plate disposed above the substrate; and a lower covering plate disposed under the substrate. A gap between an upper end face of the substrate and the upper covering plate is sealed, a gap between a lower end face of the substrate and the lower covering plate is sealed, and the substrate is provided with a via hole penetrating the upper end face and the lower end face.

In one embodiment, the chip is a microfluidic chip, and the via hole includes one or more of a micro channel, a reaction chamber and a detection chamber.

In one embodiment, the gap between the upper end face of the substrate and the upper covering plate is directly sealed, and/or the gap between the lower end face of the substrate and the lower covering plate is directly sealed.

In one embodiment, the gap between the upper end face of the substrate and the upper covering plate is sealed by a medium, and/or the gap between the lower end face of the substrate and the lower covering plate is sealed by a medium.

In one embodiment, the medium is composed of an adhesive layer.

In one embodiment, the adhesive layer is made of a pressure-sensitive double-sided adhesive, a UV-Curing adhesive or an optical grade double-sided adhesive.

In one embodiment, the upper covering plate and/or the lower covering plate are made of a plate or a film, and are made of a material of one of silicon, glass, and quartz.

In one embodiment, the upper covering plate and/or the lower covering plate are made of a plate or a film, and are made of a material of a thermoplastic polymer.

In one embodiment, the thermoplastic polymer includes one or more of polydimethyl methacrylate, polycarbonate, polystyrene, polyamide, and polyethylene terephthalate.

Another aspect of the present application provides a packaging method of a chip for sample detection, which includes: sealing a gap between an upper end face of a substrate and an upper covering plate; and sealing a gap between a lower end face of the substrate and a lower covering plate. The substrate is disposed between the upper covering plate and the lower covering plate, and the substrate is provided with a via hole penetrating the upper end face and the lower end face.

In one embodiment, the sealing a gap between an upper end face of a substrate and an upper covering plate includes: binding an adhesive layer and the upper covering plate; and sealing the gap between the upper covering plate which is bound to the adhesive layer and the upper end face of the substrate.

In one embodiment, the sealing a gap between a lower end face of the substrate and a lower covering plate includes: binding an adhesive layer and the lower covering plate; and sealing the gap between the lower covering plate which is bound to the adhesive layer and the lower end face of the substrate.

In one embodiment, the adhesive layer is made of a pressure-sensitive double-sided adhesive, a UV-Curing adhesive or an optical grade double-sided adhesive.

In one embodiment, the upper covering plate and/or the lower covering plate are made of a plate or a film, and are made of a material of one of glass, quartz and a thermoplastic polymer.

In one embodiment, the chip is a microfluidic chip, and the via hole includes one or more of a micro channel, a reaction chamber and a detection chamber.

In the chip for sample detection provided by the embodiments of the present application, the via hole designed on the substrate of the chip is penetrated, so requirements of a material of the substrate for light transmittance is reduced, so that selection of the material of the substrate is not limited, which on the one hand reduces material cost, and on the other hand, correspondingly reduces processing requirements in production process of the chip to simplify a production process flow. Although a chip structure proposed in the embodiments adds a covering plate structure which needs to select a material with excellent light transmittance, pure material cost of a material of the upper/lower covering plate is only about 1/10 of cost of the material of the substrate, and there is no structure of the functional channel and the chamber, so manufacturing and processing cost may be correspondingly low. Therefore, the chip structure provided in the embodiments greatly reduces overall cost of the chip while satisfying the light transmittance.

By using the method for packaging the chip for sample detection provided by the embodiments of the present application, the reaction chamber, the detection chamber and/or the functional channel which are penetrating the substrate are sealed together by the upper covering plate and the lower covering plate to form a relatively sealed microfluidic system inside the chip, thereby realizing functions of the chip while meeting the requirements of the chip for the light transmittance, and a packaging procedure is simple and easy to operate.

### BRIEF DESCRIPTION OF DRAWINGS

FIG. 1 is a schematic structural diagram of a microfluidic chip in the prior art.

FIG. 2 is a schematic structural diagram of a chip for sample detection according to an embodiment of the present application.

FIG. 3(a) is a schematic structural diagram of a chip for sample detection according to another embodiment of the present application.

FIG. 3(b) is a sectional diagram along line A1-A2 shown in FIG. 3(a) in which the chip for sample detection is shown.

FIG. 4 is a flow chart of a packaging method of a chip for sample detection according to an embodiment of the present application.

FIG. 5 is a flow chart of a packaging method of a chip for sample detection according to another embodiment of the present application.

### DETAILED DESCRIPTION OF THE EMBODIMENTS

In order to make the objects, technical solutions and advantages of the present application clearer, the present application will be further described in detail below in combination with the accompanying drawings.

FIG. 1 is a schematic structural diagram of a microfluidic chip in the prior art. As shown in FIG. 1, the current microfluidic chip is mainly composed of two parts which includes a substrate 11 and a covering plate 12, and a micro channel 13 is formed on the substrate 11, and the substrate 11 having the micro channel 13 is packaged with a covering plate 12, which makes the micro channel 13 be in a relatively sealed state.

When the microfluidic chip is applied in optical detection, the sample to be detected and a reagent are placed in a detection region to do the reaction, and substances generated after the detection and reaction are detected by an optical method. This requires that material of the chip has a very small degree of absorption of light to reduce the influence of the material itself on the optical detection as much as possible. The chip has high requirements on light transmittance (especially ultraviolet band light, in 340 nm wavelength), so a material with excellent transmittance is selected as the material of the chip generally, such as plastic, glass or quartz. The price of the material itself is relatively expensive, and a plurality of micro channels and various chambers for the optical detection may be designed on the substrate of the chip, which requires high processing requirements, making production process more complicated and further leading to high production cost of the chip.

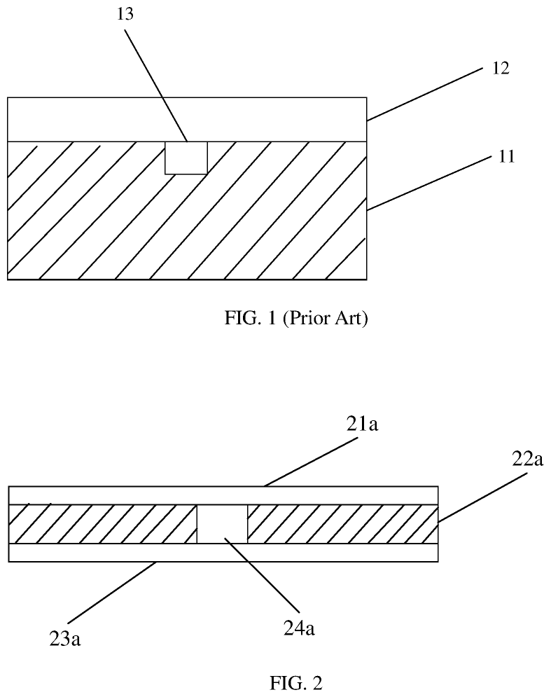

FIG. 2 is a schematic structural diagram of a chip for sample detection according to an embodiment of the present application. As shown in FIG. 2, the chip includes a substrate 22a; an upper covering plate 21a disposed above the substrate 22a; and a lower covering plate 23a disposed under the substrate 22a. A gap between an upper end face of the substrate 22a and the upper covering plate 21a is sealed, a gap between a lower end face of the substrate 22a and the lower covering plate 23a is sealed, and the substrate 22a is provided with a via hole 24a penetrating the upper end face and the lower end face.

A shape and a size of the upper covering plate 21a and the lower covering plate 23a are the same as that of the substrate 22a, and a shape of the chip may be circular, oval, rectangle, square or another arbitrary polygon.

As for the material of the upper covering plate 21a and the lower covering plate 23a, a plate (generally having a thickness of more than 0.5 mm) or a film (generally having a thickness of less than 0.5 mm) can be selected. The material of the upper covering plate 21a and the material of the lower covering plate 23a may be the same or different, and may be specifically selected from a material with good light transmittance, such as glass, quartz or thermoplastic polymers. Similarly, the processing manners of the upper covering plate 21a and the lower covering plate 23a may be the same or different, and may adopt manufacturing process such as injection molding and die-cutting, which is not limited in the present application.

The material of the substrate 22a may be selected from a material with good light transmittance, such as glass, quartz or thermoplastic polymers, or a material such as metal or alloy, as long as the penetrated via hole 24a may be formed on the substrate 22a, which is not limited in the present application. The processing manner of the substrate 22a may be selected from the manners such as injection molding, precision carving or 3D printing, which is also not limited in the present application.

A sealing method of the gap between the upper end face of the substrate 22a and the upper covering plate 21a and the gap between the lower end face of the substrate 22a and the lower covering plate 23a may be the same or different. The sealing method mainly includes two types which includes a direct packaging method and an indirect packaging method. The direct packaging method refers to a method in which contact surfaces of material of the chip reach a molten state by means of heating, ultrasonic vibration, etc., and then two layers of a chip structure will be packaged together by curing, specifically including a heat sealing method, a laser welding method or an ultrasonic welding method, etc., without needs for other medium between the two layers of the chip. The indirect packaging method mainly involves sticking a medium between the two layers and sealing the two layers of the chip structure by curing the medium. The medium in the middle is generally composed of an adhesive layer, which specifically may be made of a pressure-sensitive double-sided adhesive, a UV-Curing adhesive or an optical grade double-sided adhesive.

In the embodiment, as shown in FIG. 2, a gap between the upper end face of the substrate 22a and the upper covering plate 21a and a gap between the lower end face of the substrate 22a and the lower covering plate 23a are sealed by the direct packaging method. In other embodiments, one of the gap between the upper end face of the substrate 22a and the upper covering plate 21a and the gap between the lower end face of the substrate 22a and the lower covering plate 23a may also be selected to adopt the indirect packaging method, the other adopts the direct packaging method, or both adopt the indirect packaging method.

The via hole 24a specifically includes a reaction chamber, a detection chamber, and/or a functional channel configured to connect the reaction chamber and the detection chamber, and the like. A shape and number of the via holes 24a may be differently set according to specific demands or actual demands, for example, the shape of the via holes 24a may be selected from a circle, an ellipse, a square or other polygons, and the number of the via holes 24a may be 1 to 30 or more than 30, and the shape and the number of the via holes 24a are not limited in the present application. A distribution position of the via holes 24a on the substrate 22a is also set according to the actual demands of those skilled in the art, and is generally distributed outwardly at a center of the chip.

In the chip for sample detection provided in the embodiments, the via hole designed on the substrate of the chip is penetrated, so requirements of a material of the substrate for light transmittance is reduced, so that selection of the material of the substrate is not limited, which on the one hand reduces material cost, and on the other hand, correspondingly reduces processing requirements in production process of the chip to simplify a production process flow. Although a chip structure proposed in the embodiments adds a covering plate structure which needs to select a material with excellent light transmittance, since pure material cost of a material of the upper/lower covering plate is only about 1/10 of cost of the material of the substrate, and there is no structure of the functional channel and the chamber, manufacturing and processing cost may be correspondingly low. Therefore, the chip structure provided in the embodiments greatly reduces overall cost of the chip while satisfying the light transmittance.

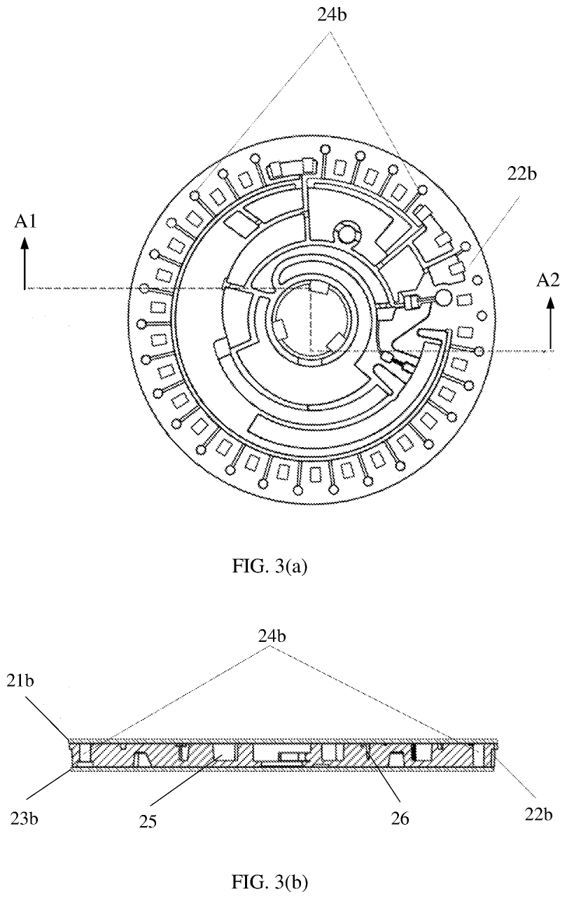

FIG. 3(a) is a schematic structural diagram of a chip for sample detection according to another embodiment of the present application. The embodiment is basically the same as the embodiment shown in FIG. 2, and the differences will be mainly described below, and the same portions will not be repeatedly described. As shown in FIG. 3(a) and FIG. 3(b), the chip for sample detection provided in the embodiment is a microfluidic chip, and includes a substrate 22b, an upper covering plate 21b disposed above the substrate 22b, and a lower covering plate 23b disposed under the substrate 22b. The substrate 22b is provided with a detection chamber, a reaction chamber 25 and a micro channel 26, the detection chamber is penetrating, and the reaction chamber 25 and the micro channel 26 are non-penetrating, i.e., via holes 24b only include the detection chamber. The microfluidic chip is configured to detect an index in the human body. As long as the detection chamber has high light transmittance, the reaction chamber 25 and the micro channel 26 have no special requirements for the light transmittance, so the reaction chamber 25 and the micro channel 26 can be set to be non-penetrating. In the microfluidic chip of other embodiments, one or more of the reaction chamber, the detection chamber and the micro channel may be designed as a form of the via hole according to specific demands, which is not limited in the present application.

As shown in FIG. 3(a), the reaction chamber 25 and the micro channel 26 are disposed in an intermediate region of the chip, and the detection chamber (i.e., the via holes 24b) is disposed at an edge of the chip around the reaction chamber 25 and the micro channel 26. In fact, there is no fixed relationship between positions of the reaction chamber 25, the detection chamber and the micro channel 26 and numbers of the reaction chambers 25, the detection chambers and the micro channels 26 may also be differently set according to the specific demands of those skilled in the art, which are not specifically limited in the present application. In addition, a size and a shape of a plurality of via holes 24b on a same chip may be the same or different, and those skilled in the art may also make different selections according to the specific demands, which is not limited in the present application.

The upper covering plate 21b and/or the lower covering plate 23b in the embodiment are made of a material of a transparent film, and a thickness of the transparent film is generally from 0.05 mm to 0.5 mm. The material may be selected from thermoplastic polymers, specifically including one or more of PMMA (polymethyl methacrylate), PC (polycarbonate), PS (polystyrene), PA (polyamide) and PET (polyethylene terephthalate). Compared with conventional glass and quartz, the thermoplastic polymers have lower cost and lower manufacturing and processing cost, and are more suitable for large-scale industrial production.

The substrate 22b may be made of ABS resin (acrylonitrile butadiene styrene copolymer) or PMMA, which has characteristics of high strength, good toughness, low cost, easy processing and molding.

The gap between the upper end face of the substrate 22b and the upper covering plate 21b and the gap between the lower end face of the substrate 22b and the lower covering plate 23b are sealed by the indirect packaging method. Specifically, upper and lower layers of the chip structure are sealed together by curing an adhesive layer, and the adhesive layer is specifically made of one of a pressure-sensitive double-sided adhesive, a UV-Curing adhesive and an optical grade double-sided adhesive.

The chip for sample detection provided by the embodiments is substantially the microfluidic chip, and the reaction chamber, the detection chamber and the penetrated micro channel on the substrate are packaged together by the upper covering plate and the lower covering plate to form a relatively sealed microfluidic system inside the chip, which realizes functions of the microfluidic chip and reduces the requirements of the material of the substrate for ultraviolet band light transmittance. In addition, the material of the upper covering plate and/or the lower covering plate are made of the thermoplastic polymer, which have lower cost and manufacturing and processing cost and are suitable for large-scale industrial production. The indirect packaging method adopted between the substrate and the upper covering plate and between the substrate and the lower covering plate may be performed at normal temperature and does not require specialized equipment for packaging, which improves package yield of the chip and reduces the cost of the chip, and is also suitable for the large-scale industrial production.

Hereinafter, the light transmittance of the specific chip structure provided in the embodiments will be compared with the light transmittance of a chip structure in the prior art, which will help to understand the present application. However, it should be understood that specific materials and packaging methods used below are not limited in the present application.

An experimental instrument used in the experiment is the Celecare M1, which is an automatic biochemical analyzer (detection wavelength is 340 nm/800 nm) produced by Tianjin MNCHIP Technologies Co., Ltd. In this experiment, the instrument mainly detects the light transmittance of the chip for 340 nm ultraviolet band light. The chips to be detected were divided into two groups. The first group is the chip structure in the embodiment of the present application, including upper and lower covering plates, and a detection hole in the substrate is penetrated. The material of the substrate is high transmittance PMMA, and the materials of the upper covering plate and the lower covering plate are respectively adopted a PC film with high light transmittance, and a gap between the upper covering plate and the substrate and a gap between the lower covering plate and the substrate are respectively sealed by the pressure-sensitive double-sided adhesive. The second group is the chip structure in the prior art, which only includes the upper covering plate, and the detection hole in the substrate is not penetrated. The material of the substrate is the PMMA with high light transmittance, the upper covering plate is made of the PC film with high light transmittance, and a gap between the upper covering plate and the substrate is sealed by the pressure-sensitive double-sided adhesive.

The two groups of chips were respectively performed light source exposure detection and light intensity values before and after the light passed through the upper covering plate of the PC film were counted, thus the absorbance degrees and transmittance were calculated. Each group includes 10 pieces of test samples, and test result is shown in Table 1.

TABLE 1
Data Comparison of Transmittance Experiments

| First group | | | | Second group | | | |
|---|---|---|---|---|---|---|---|
| Incident | Exit | | | Incident | Exit | | |
| light | light | Absorbance | | light | light | Absorbance | |
| intensity | intensity | degree A₀ | Transmittance T | intensity I₀ | intensity | degree A₀ | Transmittance T |
| I₀ (cd) | I (cd) | (lg(I₀/I)) | (%) | (cd) | I (cd) | (lg(I₀/I)) | (%) |
| 13295 | 12214 | 0.03683 | 0.91869 | 13321 | 11210 | 0.07493 | 0.84152 |
| 13256 | 12196 | 0.03619 | 0.92003 | 13305 | 11232 | 0.07355 | 0.84419 |
| 13279 | 12179 | 0.03755 | 0.91716 | 13352 | 11225 | 0.07535 | 0.84069 |
| 13263 | 12183 | 0.03688 | 0.91857 | 13296 | 11165 | 0.07586 | 0.83972 |
| 13302 | 12210 | 0.03727 | 0.91790 | 13315 | 11245 | 0.07338 | 0.84453 |
| 13285 | 12178 | 0.03778 | 0.91667 | 13288 | 11196 | 0.07439 | 0.84256 |
| 13312 | 12215 | 0.03734 | 0.91759 | 13321 | 11221 | 0.07450 | 0.84235 |
| 13289 | 12185 | 0.03766 | 0.91692 | 13279 | 11187 | 0.07445 | 0.84245 |
| 13311 | 12121 | 0.03745 | 0.91736 | 13310 | 11206 | 0.07472 | 0.84192 |
| 13298 | 12198 | 0.03749 | 0.91728 | 13321 | 11210 | 0.07493 | 0.84152 |

Through the above comparison experiments, it is found that the light transmittance of the second group of chip (i.e. the chip in the prior art) is only about 84% in the 340 nm band, while that of the first group of chip (i.e. the chip in the embodiment of the present application) is over 91% in the 340 nm band, which fully meets requirements of the chip for the ultraviolet band light transmittance. It can be seen that the chip structure provided in the embodiment of the present application reduces the overall cost and simplifies the production process under a condition of improving the light transmittance of the chip itself.

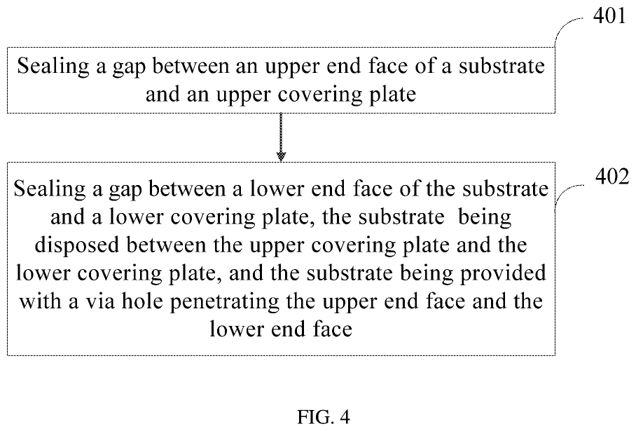

FIG. 4 is a flow chart of a method for packaging a chip for sample detection according to an embodiment of the present application. As shown in FIG. 4, the method includes:

Step 401: sealing a gap between an upper end face of a substrate and an upper covering plate;

Step 402: sealing a gap between a lower end face of the substrate and a lower covering plate; the substrate being disposed between the upper covering plate and the lower covering plate, and the substrate being provided with a via hole penetrating the upper end face and the lower end face.

A shape and a size of the upper covering plate/lower covering plate described above are the same as that of the substrate, which may be either a plate (generally having a thickness of more than 0.5 mm) or a film material (generally having a thickness of less than 0.5 mm). The material of the upper covering plate and the lower covering plate may be the same or different, and are specifically replaced by a material with better light transmittance, such as glass, quartz or thermoplastic polymers. The processing manners of the upper covering plate and the lower covering plate may adopt manufacturing process such as injection molding and die-cutting, and the like.

The material of the substrate is not limited, which may be selected from a material with good light transmittance, such as glass, quartz or thermoplastic polymers, and a material such as a metal or an alloy, as long as the penetrated via hole can be formed on the substrate. The processing manner of the substrate may be selected from the manners such as the injection molding, carving or 3D printing.

The via hole specifically includes a reaction chamber, a detection chamber, and/or a functional channel configured to connect the reaction chamber and the detection chamber, and the like. A shape and number of the via holes may be differently set according to specific demands or actual demands, for example, the shape of the via holes may be selected from a circle, an ellipse, a square or other polygons, and the number of the via holes may be 1 to 30 or more than 30. A distribution position of the via holes on the substrate may also be set according to the actual demands of those skilled in the art before preparing to process the substrate.

By using the method for packaging the chip for sample detection provided by the embodiments of the present application, the reaction chamber, the detection chamber and/or the functional channel which are penetrating the substrate are sealed together by the upper covering plate and the lower covering plate to form a relatively sealed microfluidic system inside the chip, thereby realizing functions of the chip while meeting the requirements of the chip for the light transmittance, and a packaging procedure is simple and easy to operate.

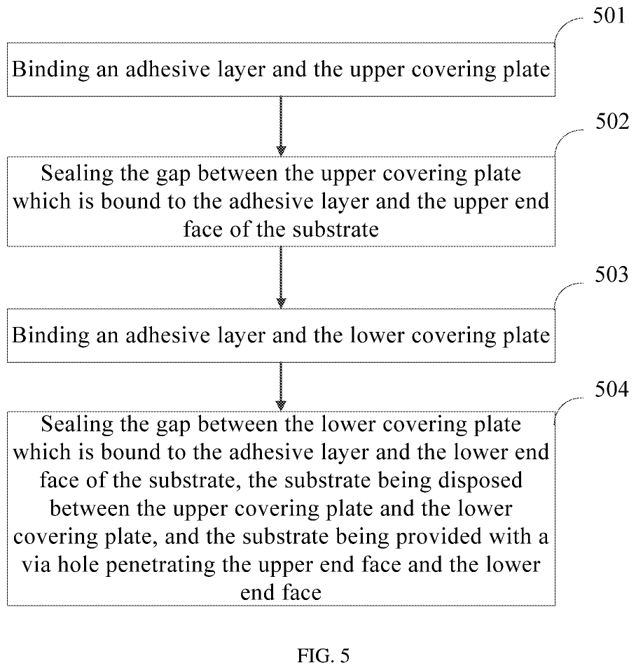

FIG. 5 is a flow chart of a method for packaging a chip for sample detection according to another embodiment of the present application. As shown in FIG. 5, the packaging method provided in the embodiment of the present application includes:

Step 501: binding an adhesive layer and the upper covering plate;

Step 502: sealing the gap between the upper covering plate which is bound to the adhesive layer and the upper end face of the substrate;

Step 503: binding an adhesive layer and the lower covering plate;

Step 504: sealing the gap between the lower covering plate which is bound to the adhesive layer and the lower end face of the substrate; the substrate being disposed between the upper covering plate and the lower covering plate, and the substrate being provided with a via hole penetrating the upper end face and the lower end face.

The via hole described above includes one or more of a reaction chamber configured to perform various biochemical reactions, a detection chamber configured to perform biochemical detection and a micro channel configured to form connecting channels. The number and the shape of the via holes may be differently set according to demands, and the chip formed may be a microfluidic chip.

The material of the upper covering plate and/or the lower covering plate may be adopted thermoplastic polymers, specifically including one or more of PMMA (polymethyl methacrylate), PC (polycarbonate), PS (polystyrene), PA (polyamide) and PET (polyethylene terephthalate). Compared with conventional glass and quartz, the thermoplastic polymers have lower cost and lower manufacturing and processing cost, and are more suitable for large-scale industrial production.

The adhesive layer in the middle may be made of a pressure-sensitive double-sided adhesive, a UV-Curing adhesive or an optical grade double-sided adhesive

By using the method for packaging the chip for sample detection provided by the embodiment, the gap between the upper covering plate and the substrate provided with the penetrated via hole and the gap between the lower covering plate and the substrate provided with the penetrated via hole are respectively sealed by the adhesive layer to form a relatively sealed microfluidic system inside the chip, thereby realizing functions of the microfluidic chip while meeting the requirements of the microfluidic chip for ultraviolet band light transmittance. A packaging process of the microfluidic chip may be performed at normal temperature and does not require specialized equipment for packaging, which improves package yield of the chip and reduces the cost of the chip, and is suitable for large-scale industrial production.

The above is only a preferred embodiment of the present application and is not used to limit the protection scope of the present application. Any modifications, equivalent replacement, improvement, etc. made in the spirit and principles of the present application shall be included in the protection scope of the present application.

What is claimed is:

1. A chip for sample detection, comprising:
a substrate;
an upper covering plate disposed above the substrate; and
a lower covering plate disposed under the substrate,
wherein a gap between an upper end face of the substrate and the upper covering plate is sealed, a gap between a lower end face of the substrate and the lower covering plate is sealed, and the substrate is provided with a via hole penetrating the upper end face and the lower end face.

2. The chip for sample detection of claim 1, wherein the chip is a microfluidic chip, and the via hole comprises one or more of a micro channel, a reaction chamber and a detection chamber.

3. The chip for sample detection of claim 1, wherein the gap between the upper end face of the substrate and the upper covering plate is directly sealed, and/or the gap between the lower end face of the substrate and the lower covering plate is directly sealed.

4. The chip for sample detection of claim 1, wherein the gap between the upper end face of the substrate and the upper covering plate is sealed by a medium, and/or the gap between the lower end face of the substrate and the lower covering plate is sealed by a medium.

5. The chip for sample detection of claim 4, wherein the medium is composed of an adhesive layer.

6. The chip for sample detection of claim 5, wherein the adhesive layer is made of a pressure-sensitive double-sided adhesive, a UV-Curing adhesive or an optical grade double-sided adhesive.

7. The chip for sample detection of claim 1, wherein the upper covering plate and/or the lower covering plate are made of a plate or a film, and are made of a material of one of glass and quartz.

8. The chip for sample detection of claim 1, wherein the upper covering plate and/or the lower covering plate are made of a plate or a film, and are made of a material of a thermoplastic polymer.

9. The chip for sample detection of claim 8, wherein the thermoplastic polymer comprises one or more of polydimethyl methacrylate, polycarbonate, polystyrene, polyamide, and polyethylene terephthalate.

10. A packaging method of a chip for sample detection, comprising:
sealing a gap between an upper end face of a substrate and an upper covering plate; and
sealing a gap between a lower end face of the substrate and a lower covering plate,
wherein the substrate is disposed between the upper covering plate and the lower covering plate, and the substrate is provided with a via hole penetrating the upper end face and the lower end face.

11. The packaging method of the chip for sample detection of claim 10, wherein the sealing a gap between an upper end face of a substrate and an upper covering plate comprises:
binding an adhesive layer and the upper covering plate; and
sealing the gap between the upper covering plate which is bound to the adhesive layer and the upper end face of the substrate.

12. The packaging method of the chip for sample detection of claim 11, wherein the adhesive layer is made of a pressure-sensitive double-sided adhesive, a UV-Curing adhesive or an optical grade double-sided adhesive.

13. The packaging method of the chip for sample detection of claim 10, wherein the sealing a gap between a lower end face of the substrate and a lower covering plate comprises:
binding an adhesive layer and the lower covering plate; and
sealing the gap between the lower covering plate which is bound to the adhesive layer and the lower end face of the substrate.

14. The packaging method of the chip for sample detection of claim 13, wherein the adhesive layer is made of a pressure-sensitive double-sided adhesive, a UV-Curing adhesive or an optical grade double-sided adhesive.

15. The packaging method of the chip for sample detection of claim 10, wherein the sealing a gap between an upper end face of a substrate and an upper covering plate comprises:
sealing the gap between the upper end face of the substrate and the upper covering plate directly.

16. The packaging method of the chip for sample detection of claim 10, wherein the sealing a gap between a lower end face of the substrate and a lower covering plate comprises:
sealing the gap between the lower end face of the substrate and the lower covering plate directly.

17. The packaging method of the chip for sample detection of claim 10, wherein the upper covering plate and/or the lower covering plate are made of a plate or a film, and are made of a material of one of glass and quartz.

18. The packaging method of the chip for sample detection of claim 10, wherein the upper covering plate and/or the lower covering plate are made of a plate or a film, and are made of a material of a thermoplastic polymer.

19. The packaging method of the chip for sample detection of claim 18, wherein the thermoplastic polymer comprises one or more of polydimethyl methacrylate, polycarbonate, polystyrene, polyamide, and polyethylene terephthalate.

20. The packaging method of the chip for sample detection of claim 10, wherein the chip is a microfluidic chip, and the via hole comprises one or more of a micro channel, a reaction chamber and a detection chamber.
